(19) United States
(12) Patent Application Publication
(10) Pub. No.: US 2008/0184691 A1
(43) Pub. Date: Aug. 7, 2008

(54) Bale forming roller

(76) Inventors: Fred M. Horchler, Lancaster, PA (US); John H. Merritt, New Holland, PA (US); Larry A. Groff, Ephrata, PA (US); Galen R. Erb, Brownstown, PA (US)

Correspondence Address: CNH AMERICA LLC, INTELLECTUAL PROPERTY LAW DEPARMENT, PO BOX 1895, M.S. 641, NEW HOLLAND, PA, 17557, US

(21) Appl. No.: 11/701,154

(22) Filed: Feb. 1, 2007

(51) Int. Cl. A01D 39/00

(52) U.S. Cl. 56/341; 29/891

(57) ABSTRACT

The apparatus is a rotatable bale forming roller for use in farm machines that form round crop bales. The roller is a cylinder with multiple ribs oriented parallel to the roller axis and formed in the roller surface. The roller is constructed with a frame of channel shaped members oriented parallel to the roller axis with the channel members interlocking with several discs oriented perpendicular to the roller axis. A thin high strength steel sheet is installed completely around the frame to form the surface of the roller, and the integral ribs are formed directly in the sheet. In the preferred embodiment, the ribs have leading surfaces oriented in planes that are radial to the axis of the roller, and the trailing surfaces of the ribs are oriented to form an acute angle with the leading surfaces.

### BACKGROUND OF THE INVENTION

This invention deals generally with farm machinery and more specifically with a bale forming roller for a machine that produces round bales.

Balers that produce cylindrically shaped bales, so called “round balers”, are now very common in the agriculture industry, and such machines are quite complex. They typically include an array of side by side endless belts following a multi-lobed looped path that travels through the machine. Multiple pivoting rollers are used to change the shape of the belt path so that it forms a bale chamber of increasing size and compresses the bale as it grows, and belts and rollers transport incoming crop into the bale chamber within which the bale is formed.

Bale forming rollers strip the crop off of the belts to begin the formation of the bale and to add crop to it so that it increases in size. The bale forming rollers also assist in making the crop move in a circular motion as it enters the bale cavity. To accomplish their function bale forming rollers are held very close to the belts and rollers and rotate in the opposite direction of belt and roller movement to contact the crop and strip the crop off the adjacent devices.

These bale forming rollers had previously been constructed with a surface that includes raised dimples, but such a surface did not perform well with certain crops that are more difficult to bale.

One approach to improve performance of such bale forming rollers has been to weld multiple round or square cross section rods onto the surface of the rollers in an orientation parallel to the axis of the roller. However, not only is this structure expensive and time consuming to construct, but the improvement is insufficient due to limitations on the size of the rods that can be used. Moreover, when the bales are being wrapped with net on the same machine, the welds can cause problems by snagging on the net.

It would be very beneficial to have available a bale forming roller that could strip crop from the belts more aggressively than the presently available rollers, but would not interfere with wrapping bales with net, and could be economically manufactured.

### SUMMARY OF THE INVENTION

The present invention is a roller with multiple ribs that are formed directly on the roller surface and oriented parallel to the roller axis. The roller is constructed with a frame of channel shaped members oriented parallel to the roller axis with the channel members interlocking with several discs oriented perpendicular to the roller axis. A steel sheet is installed completely around the frame to form the surface of the roller, and integral ribs are formed in the sheet.

The ribs are oriented parallel to the roller axis, protrude from the roller surface, and have cross sections that are shaped somewhat like triangles. The leading surfaces of the ribs, the working surfaces on the side of the direction of motion of the rotating roller, are oriented approximately on a radial plane with respect to the axis of the roller. This orientation furnishes aggressive contact with the crop on any surface adjacent to the rib, and it functions particularly well when, as in many round balers, the bale forming roller is rotated in a direction opposite to the movement of the belts from which it is stripping crop. The trailing surfaces of the ribs are at an acute angle to the leading surfaces of the ribs, to provide strength, and this shape also permits forming the ribs by conventional metal forming methods. To further simplify construction of the ribbed surface it can be formed in two or more sections and welded together to form a cylinder.

The channels within the roller frame provide radial support for the surface sheet and can also furnish locations at which the sections of the surface can be welded together and also welded to the channels. The channels interlock with the support discs which are oriented in radial planes relative to the roller axis. The webs of the channels are located in contact with the outer ribbed surface, and the sides of the channels are inserted into mating radial slots within each support disc that is internal to the roller. The two end discs do not include radial slots to mate with the channel sides, but instead have small notches in their outer circumference. These notches are aligned and mate with tabs that extend from both ends of the webs of each channel.

The discs and channels thereby fully interlock and determine the structure of the frame, and welds at the several mating locations and at the contact points between the ribbed surface and the channel webs yield a strong, rigid roller.

The preferred embodiment of the invention thereby furnishes a bale forming roll with improved performance, that eliminates the problem of net wrap catching on the rollers, and can be easily constructed by conventional manufacturing techniques.

### BRIEF DESCRIPTION OF THE DRAWINGS

FIG. 1 is a perspective view of the preferred embodiment of the bale forming roller of the invention as it appears when fully assembled.

FIG. 2 is a perspective view of the preferred embodiment of the invention with part of the roller surface removed to expose the internal frame structure.

FIG. 3 is a simplified schematic cross section view of an arc segment of the surface of the bale forming roller of the preferred embodiment of the invention viewed at section location 3-3 of FIG. 1.

### DETAILED DESCRIPTION OF THE INVENTION

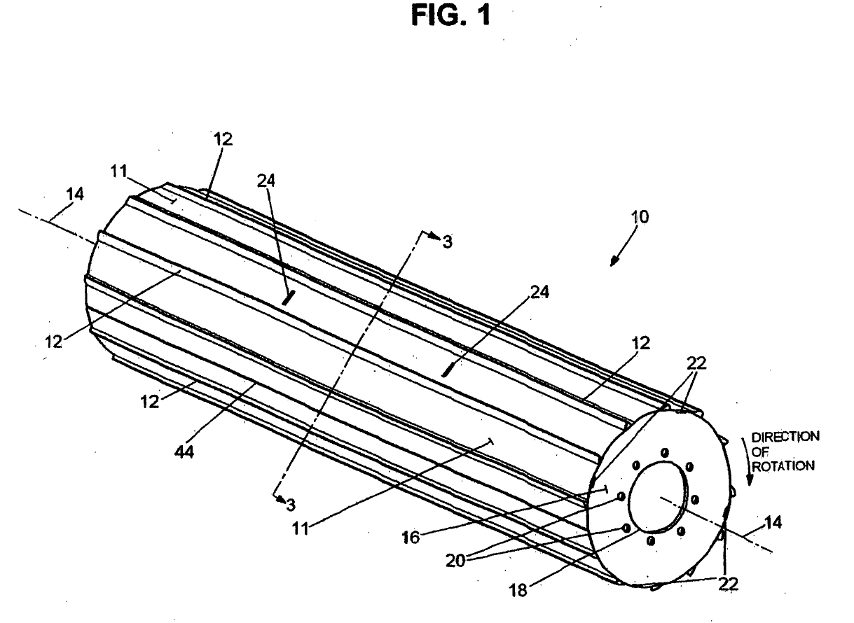

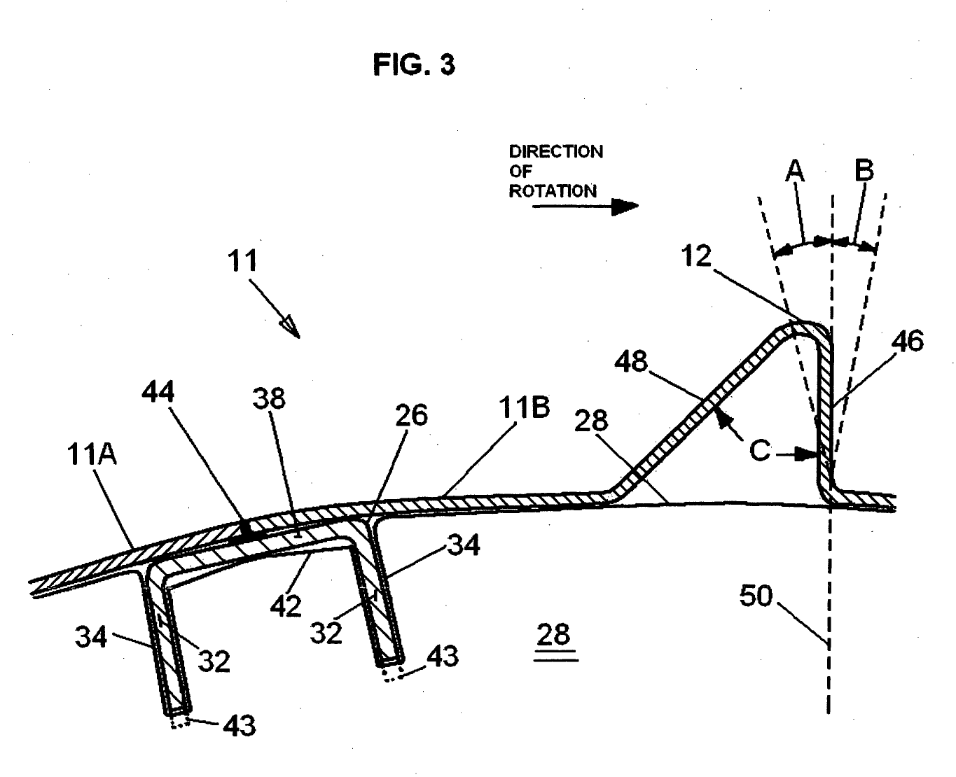

FIG. 1 is a perspective view of the preferred embodiment of bale forming roller 10 of the invention as it appears when fully assembled. Bale forming roller 10 is essentially a cylinder with exterior roller surface 11 which has multiple spaced apart ribs 12 oriented parallel to roller axis 14. The cross sections of the ribs are similar to triangles with the leading surfaces of the ribs, based on the direction of roller rotation, oriented in a plane that is approximately radial to roller axis 14. This configuration of ribs 12 is shown in FIG. 3 but can also be seen along the circumference of end disc 16 of roller 10.

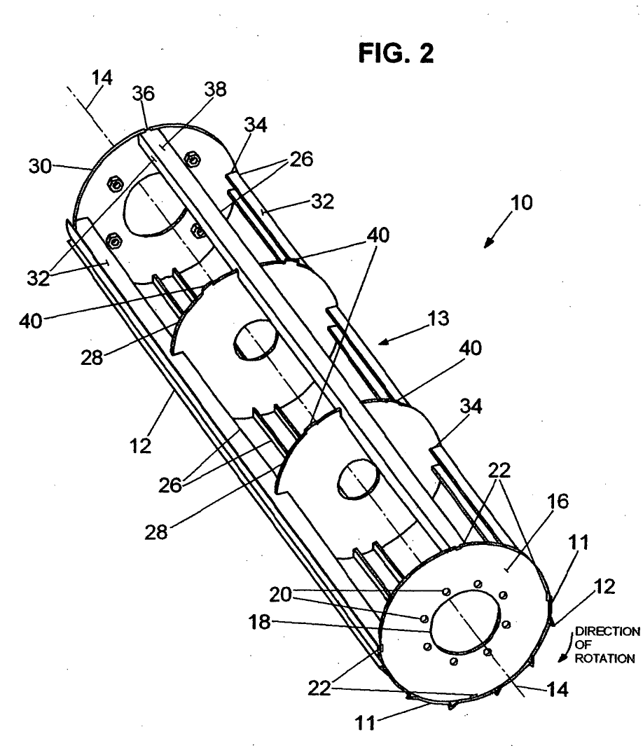

End disc 16 has center hole 18 and bolt holes 20 for attachment to a drive gear (not shown). Notches 22 can also be seen along the circumference of end disc 16. Notches 22 and slots 24 are parts of the interlocking system of components of roller 10, which is shown more clearly in FIG. 2.

FIG. 2 is a perspective view of the preferred embodiment of roller 10 of the invention with part of roller surface 11 removed to expose the structure of internal frame 13. Frame 13 of roller 10 is constructed of longitudinal channels 26 oriented parallel to roller axis 14 with channels 26 interlocking with and welded to internal support discs 28 and end discs 16 and 30. Internal support discs 28 and end discs 16 and 30 are located in planes perpendicular to roller axis 14.

The interlocking action between channels 26 and internal support discs 28 is accomplished by inserting channel sides 32 into radial slots 34 within internal support discs 28 and is shown more clearly in FIG. 3. The interlocking action between channels 26 and end discs 16 and 30 is attained by tabs 36 that extend from the ends of channel webs 38, with the tabs fitting into notches 22 on the circumferences of end discs 16 and 30.

These interlocking actions provide for simple, foolproof assembly of the several component parts and hold the parts together and properly located until they are permanently welded together. Once frame 13 is permanently assembled, roller surface 11 with ribs 12 is attached to frame 13.

Roller surface 11 can be constructed of one or more preformed sections. FIG. 2 depicts the preferred embodiment in which frame 13 would support two sections, each covering one-half of frame 13, and one section of surface 11 with ribs 12 is visible along the lower half of end disc 16. FIG. 1 and FIG. 2 together also show the components for interlocking and attaching roller surface 11 to frame 13. Slots 24, seen in FIG. 1 on roller surface 11, are placed in several locations around the circumference of roller surface 11 so that they are aligned and mate with tabs 40 protruding from the circumferences of internal support discs 28. Tabs 40 are dimensioned so that their heights are approximately the same as the thickness of the material forming roller surface 11. Thus, as preformed surface sections 11 are placed on frame 13, surface sections 11 are aligned with frame 13 by fitting slots 24 over tabs 40. The tabs then are welded to surface section 11, and with the welds properly ground down, there is no discontinuity in the surface.

FIG. 3 is a simplified schematic cross section view of an arc segment of surface 11 of roller 10 of the preferred embodiment of the invention with the view taken at section 3-3 of FIG. 1. FIG. 3 shows several important features of roller 10, the shape and orientation of rib 12 and the interlocking structures of channels 26 and internal support discs 28.

Sides 32 of channels 26 are inserted into mating pairs of radial slots 34 formed in internal support discs 28 as the principal interlocking action, but other features also assure the proper location of the components. Internal support discs 28 have the space between each pair of slots 34 trimmed down to a depth 42 that accommodates the thickness of webs 38 of channels 26. This allows the tops of channel webs 38 to be essentially level with the circumference of internal support discs 28, and prevents a potential discontinuity in the support for roller surface 11.

An additional interlocking mechanism is the formation of channel slots 43 in the lower edges of channel sides 32. Channel slots 43 in channel sides 32 are located and dimensioned to fit over and mate with internal support discs 28 at the bottom of radial slots 34 that are in internal support discs 28. The mating of channel slots 43 and internal support discs 28 thereby determines the longitudinal locations of both channels 26 and internal support discs 28, and once the junctions of slots 43 and internal support discs 28 are welded, these longitudinal locations are locked in.

FIG. 3 also shows the preferred location of welds 44 between individual surface sections 11A and 11B of roller surface 11. Welds 44 run the length of roller 10, and one such weld can be seen in FIG. 1. It should be appreciated that welds 44 are aligned with webs 38 of channels 26, and they not only bond together individual surface sections 11A and 11B, but they also bond the two sections to channels 26.

The structure, shape, and orientation of ribs 12 are also shown in FIG. 3. Ribs 12 are preformed into roller surface 11, and the cross sections of ribs 12 have leading surfaces 46 positioned in the direction of roller rotation and sloping surfaces 48 as the trailing surfaces, the surfaces facing opposite of the direction of rotation.

Leading surfaces 46 are the working surfaces of ribs 12 and aggressively contact the crop on any surface adjacent to the ribs. To accomplish this, leading surfaces 46 of the preferred embodiment are oriented on planes 50 which are radial to axis 14 of roller 10. However, variations from the radial plane in the range of between 0 and 30 degrees leaning away from the direction of rotation as shown by angle A and in the range of between 0 and 30 degrees leaning into the direction of rotation as indicated by angle B are also possible.

Trailing surfaces 48 of the ribs are oriented in planes at acute angle C to the planes of leading surfaces 46 to provide strength, and this shape also permits forming the ribs by conventional metal forming methods. In the preferred embodiment of roller 10, angle C is 54 degrees, but it will satisfactorily fulfill its requirements in a range of between 0 and 70 degrees.

The bale forming roller of the preferred embodiment of the invention typically has a length of 4 to 5 feet, a diameter of 240 mm, and has twelve ribs that are each 6 mm high. Roller surface 11 including ribs 12 is constructed of high strength grade 50 formable steel which is 2 mm thick. However, it should be appreciated that the roller dimensions are not critical to the operation of the invention, and they can be adjusted for the application and the particular type of crop. In fact, the material and thickness of roller surface 11 is largely determined by the capability of the manufacturing process to form ribs 12.

The preferred embodiment of the invention thereby furnishes a bale forming roll with improved performance, it eliminates the problem of net wrap catching on the rollers, and it can easily be constructed by conventional manufacturing techniques.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims. For example, additional channels and internal support discs, different rib heights, and more or fewer ribs and surface sections are possible within the scope of the invention.

What is claimed as new and for which Letters patent of the United States are desired to be secured is:

1. A bale forming roller comprising:
a cylinder with an axis and a circumferential cylinder surface;
protruding ribs oriented parallel to the cylinder axis and formed integrally into the cylinder surface; and
two end discs forming boundaries at the ends of the cylinder and at least partially closing off the interior of the cylinder.

2. The bale forming roller of claim 1 further including an internal frame structure supporting and attached to the cylinder surface.

3. The bale forming roller of claim 1 further including an internal frame structure supporting and attached to the cylinder surface wherein the internal frame structure comprises:
at least one internal support disc oriented perpendicular to the cylinder axis;
at least two longitudinal support structures attached to the internal support disc, the two end discs, and the cylinder surface.

4. The bale forming roller of claim 3 wherein the longitudinal support structures are channels with webs connecting sides, and the channels are oriented parallel to the cylinder axis, with the sides of the channels inserted into slots formed into at least one internal support disc.

5. The bale forming roller of claim 3 wherein the longitudinal support structures are channels with webs connecting sides, and the channels are oriented parallel to the cylinder axis, with the sides of the channels inserted into slots formed into at least one internal support disc, and with the channels further including tabs extending from the ends of the webs and with the tabs inserted into and attached to mating notches formed in the end discs.

6. The bale forming roller of claim 3 wherein at least one internal support disc includes at least one tab extending out from the edge of the disc, and the tab is inserted into and attached to a mating slot in the cylinder surface.

7. The bale forming roller of claim 1 wherein the ribs are formed with cross sections shaped from leading surfaces on the sides of the ribs which are in the direction of intended rotation of the roller and with trailing surfaces on the sides of the ribs which are in the direction opposite from the intended rotation of the roller, and with the leading surfaces located in planes that are oriented in the range of between 0 and 30 degrees to a plane that is radial to the axis of the roller.

8. The bale forming roller of claim 1 wherein the ribs are formed with cross sections shaped from leading surfaces on the sides of the ribs which are in the direction of intended rotation of the roller and trailing surfaces on the sides of the ribs which are in the direction opposite from the intended rotation of the roller, and with the trailing surfaces oriented in planes that are at angles in a range of between 0 and 70 degrees to the planes of the leading surfaces.

9. A method of constructing a bale forming roller comprising:
constructing an internal frame structure by attaching at least two parallel longitudinal support structures to at least one internal support disc and to two end discs that form boundaries at the ends of the frame structure;
forming at least two segments of a cylindrical surface to cover the internal frame structure;
forming parallel ribs integrally into the segments of the cylinder surfaces; and
attaching the at least two segments of the cylindrical surface to the internal frame structure with the ribs oriented parallel to the roller axis and with the ribs protruding from the outside surfaces of segments.

10. The method of claim 9 further including forming the ribs with cross sections shaped from leading surfaces on the sides of the ribs which are in the direction of intended rotation of the roller and with trailing surfaces on the sides of the ribs which are in the direction opposite from the intended rotation of the roller, and with the leading surfaces located in planes that are oriented in the range of between 0 and 30 degrees to a plane that is radial to the axis of the roller.

11. The method of claim 9 further including forming the ribs with cross sections shaped from leading surfaces on the sides of the ribs which are in the direction of intended rotation of the roller and trailing surfaces on the sides of the ribs which are in the direction opposite from the intended rotation of the roller, and with the trailing surfaces oriented in planes that are at angles in a range of between 0 and 70 degrees to the planes of the leading surfaces.
